(19) United States
(12) Patent Application Publication
(10) Pub. No.: US 2017/0041242 A1
(43) Pub. Date: Feb. 9, 2017

(54) NETWORK SYSTEM, COMMUNICATION ANALYSIS METHOD AND ANALYSIS APPARATUS

(71) Applicant: HITACHI, LTD., Tokyo (JP)

(72) Inventor: Takashi ISOBE, Tokyo (JP)

(73) Assignee: HITACHI, LTD., Tokyo (JP)

(21) Appl. No.: 15/205,699

(22) Filed: Jul. 8, 2016

(30) Foreign Application Priority Data
Aug. 5, 2015 (JP) 2015-155363

(51) Int. Cl. H04L 12/801; H04L 12/715; H04L 12/24

(52) U.S. Cl. CPC H04L 47/29; H04L 41/0893; H04L 45/46

(57) ABSTRACT

A network system comprising a plurality of communication apparatuses, wherein the network system includes an analysis part for analyzing a communication flow to classify a plurality of communication flows by communication types. The analysis part includes: a feature amount obtaining part for obtaining, for each of the plurality of communication flows, management information on the communication flow including a plurality of feature amounts; a cluster analysis part for analyzing the management information on the communication flow to generate a plurality of clusters each made up of the plurality of communication flows; and a cluster classification part for classifying the plurality of clusters by communication types based on an analysis result obtained using at least one of the plurality of feature amounts of the plurality of communication flows included in each of the plurality of clusters.

### CLAIM OF PRIORITY

The present application claims priority from Japanese patent application JP 2015-155363 filed on Aug. 5, 2015, the content of which is hereby incorporated by reference into this application.

### BACKGROUND OF THE INVENTION

The present invention relates to a network system, classification method, and apparatus configured to classify a communication flow by the type of communication using feature amounts of each communication flow.

A communication apparatus measures communication quality or communication speed of a communication flow by analyzing the packets of the communication flow, classifies the communication flow by the type of communication based on the measurement result, and actively applies various communication services based on the classification result. Examples of the technique to classify the communication flow include the technique disclosed in Japanese Patent Application Laid-open Publication No. 2014-154888 A is known.

Japanese Patent Application Laid-open Publication No. 2014-154888 A describes the following technique: two consecutive pieces of communication data Xn and Xn+1 are obtained from a communication data storage means, and if the time interval between the communication data Xn and Xn+1 is equal to or greater than a prescribed threshold Tc, the two pieces of communication data are separate communication clusters, and the communication data Xn+1 is defined as an independent communication. On the other hand, if the time interval is smaller than the threshold Tc, the two pieces of communication data belong to the same communication cluster, and the communication data Xn+1 is defined as a dependent communication. The communication Xn+2, which is the subsequent communication data to the communication data Xn+1 defined as the independent communication, is obtained from the communication data storage means, and if the difference between the communication data Xn+2 and the communication data Xn+1 is smaller than a prescribed independent communication identification threshold Tf, the communication data Xn+1 is defined as a dependent communication. The classification results are stored in a classification result storage means together with communication identifiers that uniquely identify the respective pieces of communication data.

### SUMMARY OF THE INVENTION

In a case where communication flows are classified by extracting feature amounts such as throughput, delay time, packet loss rate, and communication duration for each communication flow and comparing those feature amounts with threshold values, the classification results of the communication flow are affected by fluctuation and change in feature amounts, or statistical distribution and statistical errors. That is, it is difficult to classify the communication flow so as to achieve consistent communication control. Furthermore, in the conventional configuration, communication flows are classified using preset thresholds only, and therefore, it was not possible to classify a communication flow that has an unknown feature amount.

For example, when the communication flows between two locations are analyzed, there is a case in which the packet loss rate or communication delay increases temporarily in one communication flow, while the packet loss rate or communication delay temporarily decreases in the other communication flow. In this case, the classification results of the communications keep changing, and therefore, it is not possible to accurately determine whether or not it is necessary to apply a communication service for improving communication quality such as a WAN accelerator.

The present invention was made to provide a system and method for classifying communication flows without being affected by fluctuation and change in feature amounts of the communication flows or statistical distribution and statistical errors.

The present invention can be appreciated by the description which follows in conjunction with the following figures, wherein: a network system comprising a plurality of communication apparatuses configured to control communications between a plurality of terminals that are coupled via a network. Each of the plurality of communication apparatuses includes an arithmetic device, and a storage device coupled to the arithmetic device. The network system includes an analysis part for analyzing a communication flow that is a control unit for the communication between the plurality of terminals to classify a plurality of communication flows by communication types. The analysis part is realized by the arithmetic device included in at least one of the plurality of communication apparatuses executing a program stored in the storage device. The analysis part includes: a feature amount obtaining part that obtains, for each of the plurality of communication flows, management information on the communication flow including a plurality of feature amounts; a cluster analysis part that analyzes the management information on the communication flow to generate a plurality of clusters each made up of the plurality of communication flows; and a cluster classification part that classifies the plurality of clusters by communication types based on an analysis result obtained using at least one of the plurality of feature amounts of the plurality of communication flows included in each of the plurality of clusters.

According to the present invention, it is possible to classify communication flows without being affected by fluctuation and change in feature amounts of the communication flows or statistical distribution and statistical errors. Other objects, configurations, and effects than the above become apparent from the following description of the embodiments.

### BRIEF DESCRIPTION OF THE DRAWINGS

The present invention can be appreciated by the description which follows in conjunction with the following figures, wherein:

FIG. 1 is a diagram for explaining a configuration example of a network system of a first embodiment;

FIG. 2 is a diagram for explaining one example of a format of packet sent and received by a communication apparatus of the first embodiment;

FIG. 3 is a block diagram showing an example of the hardware configuration and software configuration of an analysis apparatus of the first embodiment;

FIG. 4A is a diagram for explaining one example of cluster classification definition information managed by the analysis apparatus of the first embodiment;

FIG. 4B is a diagram for explaining one example of cluster history information managed by the analysis apparatus of the first embodiment;

FIG. 5 is a diagram for explaining one example of feature amount management information managed by an analyzer of the first embodiment;

FIG. 6 is a diagram for explaining one example of feature amount history management information managed by a storage apparatus of the first embodiment;

FIG. 7 is a flowchart for explaining process performed by the analysis apparatus of the first embodiment;

FIGS. 8A, 8B, and 8C are diagrams each showing a display example of clusters output by an output part of the first embodiment;

FIG. 9 is a flowchart for explaining process performed by the analysis apparatus of a second embodiment;

FIG. 10 is a flowchart for explaining an example of process performed by the analysis apparatus of a third embodiment in order to detect DDoS attack;

FIG. 11 is a diagram for explaining one example of the feature amount history management information of the third embodiment;

FIG. 12 is a diagram showing an example of process results of cluster analysis in the third embodiment;

FIG. 13 is a flowchart for explaining an example of process performed by the analysis apparatus of a fourth embodiment in order to detect anomalous communication;

FIG. 14 is a diagram for explaining an example of anomalous communication detection in the fourth embodiment;

FIG. 15 is a flowchart for explaining an example of process performed by the analysis apparatus of a fifth embodiment in order to detect degradation in communication quality;

FIG. 16 is a diagram for explaining an example of detecting degradation in communication quality in the fifth embodiment;

FIG. 17 is a flowchart for explaining an example of process performed by the analysis apparatus of a sixth embodiment in order to detect preferences of each user; and

FIG. 18 is a diagram for explaining an example of detecting preferences of each user in the sixth embodiment.

### DETAILED DESCRIPTION OF THE EMBODIMENTS

Below, embodiments of the present invention will be explained in detail with reference to the appended figures. In the respective figures, the same configurations are given the same reference characters.

### First Embodiment

In first embodiment, the basic system configuration of the present invention will be explained. Modification examples or specific examples will be explained in other embodiments.

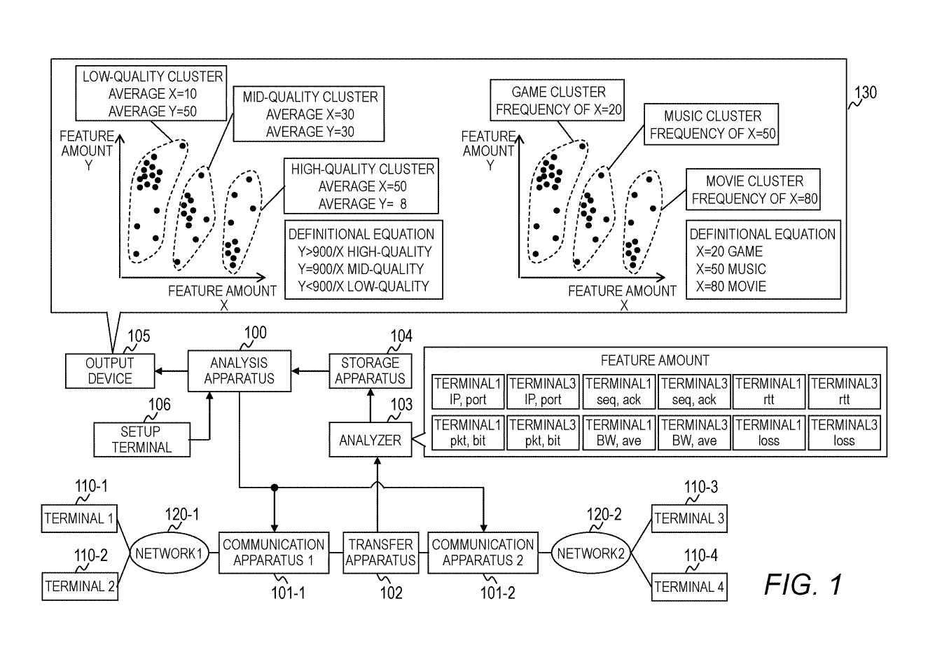

FIG. 1 is a diagram for explaining a configuration example of a network system of the first embodiment.

The network system of the first embodiment includes an analysis apparatus 100, a plurality of communication apparatuses 101, a transfer apparatus 102, an analyzer 103, a storage apparatus 104, an output device 105, a setup terminal 106, and a plurality of terminals 110.

The network system shown in FIG. 1 includes two communication apparatuses 1 (101-1) and 2 (101-2), and four terminals 1 (110-1), 2 (110-2), 3 (110-3), and 4 (110-4). Hereinafter, when it is not necessary to differentiate the communication apparatus 1 (101-1) from the communication apparatus 2 (101-2), the two are collectively referred to as communication apparatus 101, and when it is not necessary to differentiate the terminal 1 (110-1), terminal 2 (110-2), terminal 3 (110-3), and terminal 4 (110-4) from each other, the four terminals are collectively referred to as terminal 110.

The terminal 1 (110-1) and terminal 2 (110-2) are connected to the communication apparatus 1 (101-1) via network 1 (120-1), and the terminal 3 (110-3) and terminal 4 (110-4) are connected to the communication apparatus 2 (101-2) via network 2 (120-2). The communication apparatus 1 (101-1) and the communication apparatus 2 (101-2) are connected to each other via the transfer apparatus 102. The network 1 (120-1) and network 2 (120-2) are a wide area network (WAN), local area network (LAN), or the like, for example. The network 1 (120-1) and network 2 (120-2) are not limited to a specific type of network. In the descriptions below, when it is not necessary to differentiate the network 1 (120-1) and the network 2 (120-2) from each other, they are collectively referred to as network 120.

Each terminal 110 communicates with another terminal 110 connected a different network via the network 120, the communication apparatus 101, and the transfer apparatus 102. Each terminal 110 may also communicate with another terminal 110 connected a same network 120.

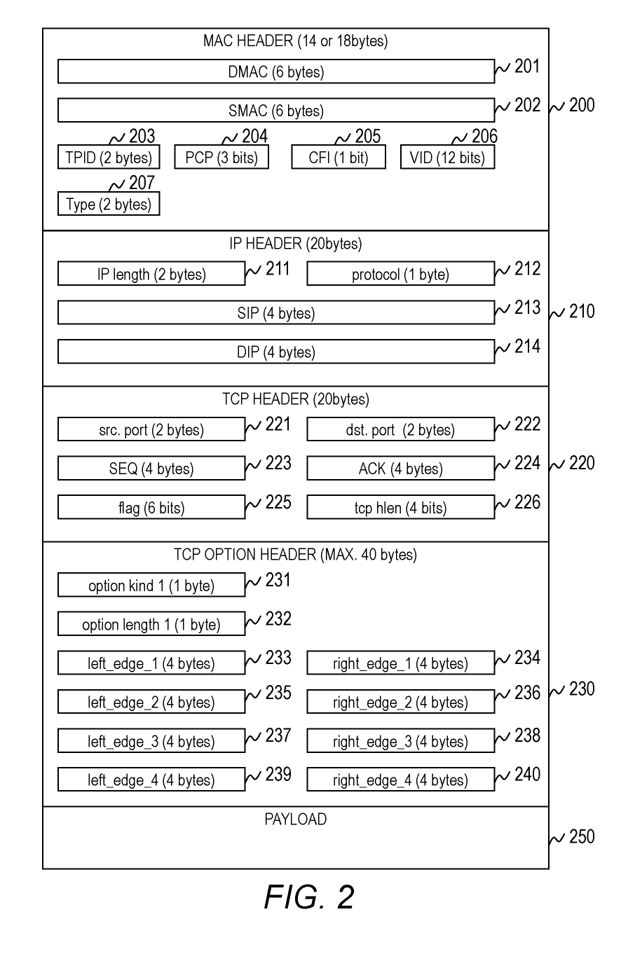

The communication apparatus 101 controls communications between a plurality of terminals 110 in each session unit. It is assumed that a session is a TCP session in the present embodiment. The communication apparatus 101 performs receiving process of packet and transmitting process of packet. The communication apparatus 101 controls packets that flow through a specific session. The communication apparatus 101 also controls communications of each session in accordance with an instruction from the analysis apparatus 100. The format of the packets that are transmitted and received by the communication apparatus 101 will be explained with reference to FIG. 2.

The transfer apparatus 102 relays the packets transmitted from the terminal 110. The transfer apparatus 102 of this embodiment has at least the mirroring function or the tap function. In a case where the transfer apparatus 102 has the mirroring function, the transfer apparatus 102 generates mirror packets based on the packets received from the communication apparatus 101, and outputs the generated mirror packets to the analyzer 103. In a case where the transfer apparatus 102 has the tap function, the transfer apparatus 102 branches the packets (signals) received from the communication apparatus 101 into two parts, and sends one packet to the communication apparatus 101 and outputs other packet to the analyzer 103.

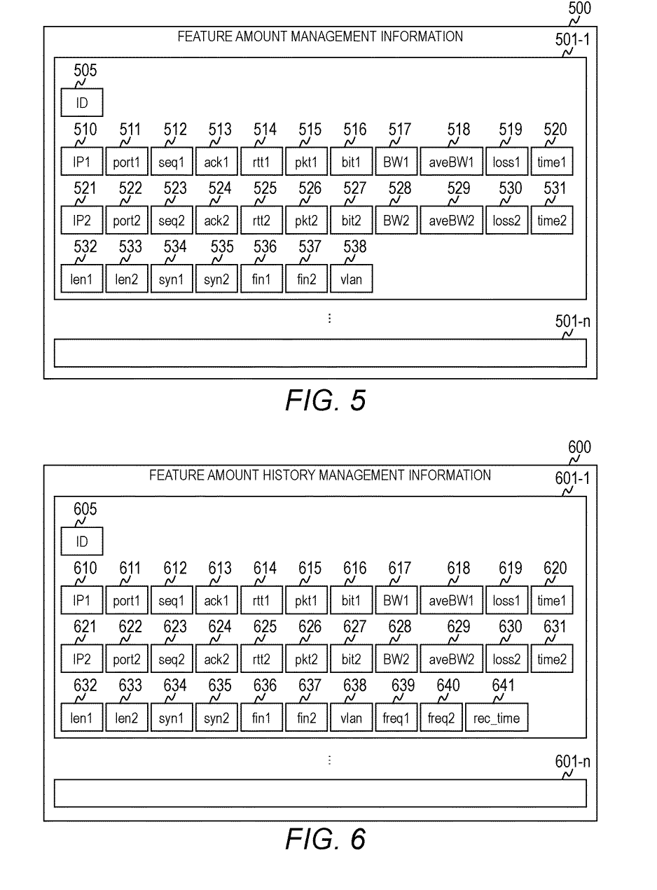

The analyzer 103 extracts feature amounts of each session based on the packets or the mirror packets obtained from the transfer apparatus 102, and manages the extracted feature amounts as feature amount management information 500 (see FIG. 5). The feature amount management information 500 (see FIG. 5) is updated in real time. The analyzer 103 periodically sends the feature amount management information 500 (see FIG. 5) to the storage apparatus 104.

When a session between the terminal 1 (110-1) and the terminal 3 (110-3), for example, feature amounts such as IP address, port number, transmission sequence number, reception sequence number, round-trip delay time, packet number, bit number, most recent bandwidth, average bandwidth, and packet loss rate are extracted for each of the terminal 1 (110-1) and the terminal 3 (110-3).

It is assumed that relationships between the feature amounts described above and the symbols in FIG. 1 are as follows. “IP” corresponds to the IP address, “port” corresponds to the port number, “seq” corresponds to the transmission sequence number, and “ack” corresponds to the reception sequence number. Also, “rtt” corresponds to the round-trip delay time, “pkt” corresponds to the packet number, and “bit” corresponds to the bit number. “BW” corresponds to the latest bandwidth, “ave” corresponds to the average bandwidth, and “loss” corresponds to the packet loss rate.

The storage apparatus 104 obtains the feature amount management information 500 (see FIG. 5) from the analyzer 103, and manages the feature amounts of each session as feature amount history management information 600 (see FIG. 6). The storage apparatus 104 may be configured to calculate new feature amounts based on the extracted feature amounts, and manage the extracted feature amounts and the newly calculated feature amounts in association with each other as necessary.

The analysis apparatus 100 performs cluster analysis based on the feature amounts of sessions. In the cluster analysis, the analysis apparatus 100 generates a plurality of clusters each made up of a plurality of sessions based on the feature amount of each session. More specifically, the analysis apparatus 100 generates the plurality of clusters by performing the unsupervised learning analysis based on the correlations between a plurality of feature amounts. Because one cluster includes two or more sessions, feature amounts of at least four sessions are input in the cluster analysis.

The analysis apparatus 100 then analyzes communications of each cluster using at least one feature amount of the plurality of sessions included in each cluster. The analysis apparatus 100 classifies the plurality of clusters by communication types based on the analysis results. In this embodiment, the classification of the communication of this embodiment is performed in cluster units, so the classification of the communication is not affected by changes in feature amounts or statistical distribution of each communication session.

The analysis apparatus 100 outputs the results of cluster analysis and results of classification to the output device 105. The analysis apparatus 100 also determines communication control content to be applied to a cluster, and notifies the communication apparatus 101 of the determined control content.

Based on the control content notified by the analysis apparatus 100, the communication apparatus 101 controls the subject sessions. This makes it possible to perform consistent communication control in cluster units.

The output device 105 includes a display, printer, or storage medium. The output device 105 issues an alert for, prints out, or stores in a memory the results of the cluster analysis and the results of classification. The output is device 105 also displays, as an image, the results of the cluster analysis and the results of classification. FIG. 1 shows an example in which the output device 105 displays the results of the cluster analysis and the results of classification as an image 130. The image 130 shows the indexes used for correlation graphs, indexes and definitional equations used for the cluster classification, types of classified clusters, and the like. Examples of the indexes used for the cluster classification include the centroid of each cluster in the correlation graph.

The image 130 displays the results of cluster classification by the level of communication quality, and the results of cluster classification by user preferences.

The setup terminal 106 is a terminal for configuring various settings of the analysis apparatus 100. In this embodiment, setup information such as information for classifying clusters and control content for sessions in a cluster is input into the analysis apparatus 100 using the setup terminal 106.

FIG. 2 is a diagram for explaining one example of the format of packet sent and received by the communication apparatus 101 of the first embodiment.

The packet includes a MAC header 200, an IP header 210, a TCP header 220, a TCP option header 230, and a payload 250.

The MAC header 200 includes a DMAC 201, a SMAC 202, a TPID 203, a PCP 204, a CFI 205, a VID 206, and a Type 207.

The DMAC 201 represents a destination MAC address. The SMAC 202 represents a source MAC address. The Type 207 represents a MAC frame type. The TPID 203 indicates that a frame type is VLAN. The PCP 204 represents a priority level of VLAN. The CFI 205 indicates whether the MAC address is in a regular expression format or not. The VID 206 represents the ID number of VLAN.

The IP header 210 includes an IP length 211, a protocol 212, a SIP 213, and a DIP 214.

The IP length 211 represents a length of the packet excluding MAC header. The Protocol 212 represents a protocol number. The SIP 213 represents a source IP address. The DIP 214 represents a destination IP address.

The TCP header 220 includes a src. port 221, a dst. port 222, a SEQ 223, an ACK 224, a flag 225, and a tcp hlen 226.

The src. port 221 represents a sender port number. The dst. port 222 is a destination port number. The SEQ 223 represents the transmission sequence number. The ACK 224 represents the reception sequence number. The flag 225 represents a TCP flag number. The tcp hlen 226 represents a header length of TCP.

The TCP option header 230 includes an option kind 1 (231), an option length 1 (232), a left_edge_1 to 4 (233, 235, 237, 239), and a right_edge_1 to 4 (234, 236, 238, 240).

The option kind 1 (231) represents an option type. The option length 1 (232) represents an option length. The left_edge_1 to 4 (233, 235, 237, 239) and the right_edge_1 to 4 (234, 236, 238, 240) are used to notify a destination terminal 110 of the position of the received partial data in a case where one piece of communication data is divided into a plurality of pieces of data upon transmission.

The left_edge_1 to 4 (233, 235, 237, 239) and the right_edge_1 to 4 (234, 236, 238, 240) are sometimes used to notify the position of partial data that was not received successfully.

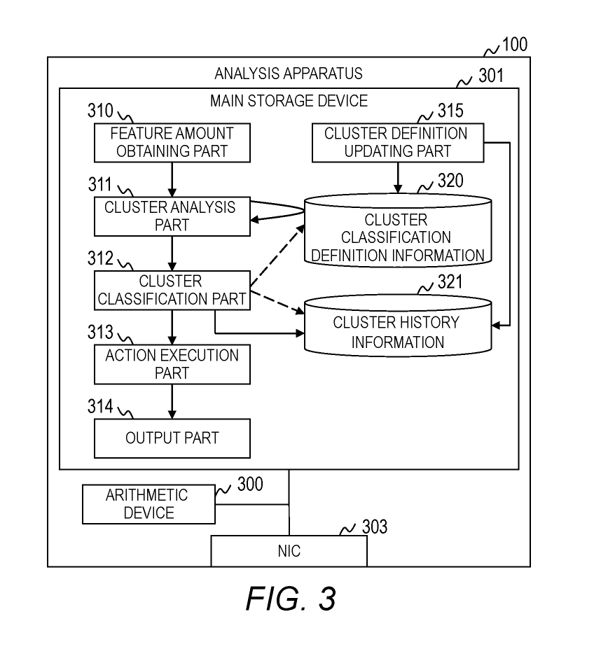

FIG. 3 is a block diagram showing an example of the hardware configuration and software configuration of the analysis apparatus 100 of the first embodiment.

The analysis apparatus 100 includes an arithmetic device 300, a main storage device 301, and a NIC 303 as hardware. The arithmetic device 300, the main storage device 301, and the NIC 303 are connected to each other via system bus or the like. It is assumed that the communication apparatus 101, the transfer apparatus 102, the analyzer 103, and the storage apparatus 104 have a hardware configuration similar to that of the analysis apparatus 100.

The arithmetic device 300 executes programs stored in the main storage device 301. Examples of the arithmetic device 300 is CPU, GPU, and the like. The functions of the analysis apparatus 100 may be realized by the arithmetic device 300 executing the programs. In the following description, when a process is explained as being performed by a function part, that means the arithmetic device 300 is executing the program that realizes such a function part.

The main storage device 301 is a storage device that stores programs to be executed by the arithmetic device 300 and information necessary to execute those programs. The main storage device 301 has storage areas such as a work area to be used by each program, a buffer, and the like. The programs and information stored in the main storage device 301 will be explained in detail below.

NIC 303 is an interface to connect to another apparatus. The analysis apparatus 100 of FIG. 3 includes only one NIC 303, but the analysis apparatus 100 may include a plurality of NICs respectively connected to the communication apparatus 101, the storage apparatus 104, the output device 105, and the setup terminal 106.

The main storage device 301 of this embodiment stores therein programs that respectively realize a feature amount obtaining part 310, a cluster analysis part 311, a cluster classification part 312, an action execution part 313, an output part 314, and a cluster definition updating part 315. The main storage device 301 also stores therein cluster classification definition information 320 and cluster history information 321.

The feature amount obtaining part 310 obtains an entry 601 that manages the feature amounts of a session from the feature amount history management information 600 stored in the storage apparatus 104, and normalizes the feature amounts included in the obtained entry 601. The feature amount obtaining part 310 then outputs the normalized feature amounts to the cluster analysis part 311. The normalization process of the feature amounts may be omitted.

The cluster analysis part 311 calculates correlations between a plurality of feature amounts using the normalized feature amounts, and generates a plurality of clusters from a plurality of sessions based on the correlations. The cluster analysis part 311 also outputs information on the generated cluster to the cluster classification part 312.

For example, in a case where feature amount vectors based on a plurality of feature amounts are used, the cluster analysis part 311 generates one cluster by grouping together a plurality of sessions each of which corresponds to the feature amount vectors whose distance is equal to or shorter than a threshold. Because a plurality of sessions are classified based on the distance between two feature amount vectors, one cluster includes at least two sessions.

The cluster classification part 312 calculates values for classifying a plurality of clusters, refers to the cluster classification definition information 320 based on the calculated values, and determines whether the generated clusters can be classified or not. In a case where there is a cluster that cannot be classified, the cluster classification part 312 refers to the cluster history information 321 to determine whether there is a cluster that matches the unclassified cluster. If there is not a cluster that matches the unclassified cluster, the cluster classification part 312 registers the unclassified cluster as an unknown cluster in the cluster history information 321.

In a case where a cluster can be classified based on the cluster classification definition information 320 or in case where there is a cluster that matches the unclassified cluster, the cluster classification part 312 outputs the control content (action) set for the cluster to the action execution part 313.

The action execution part 313 performs prescribed control based on the control content output from the cluster classification part 312. In this embodiment, a consistent control policy can be applied without being affected by a change in feature amounts, statistical distribution, and the like.

The output part 314 outputs the results of the executed action, classification results of the generated clusters, and the like to the output device 105 and the like.

The cluster definition updating part 315 updates the cluster classification definition information 320 and the cluster history information 321 based on the external input from the setup terminal 106 or the like.

The functions of a plurality of function blocks may be consolidated to one function block, or one function block may be divided into a plurality of function blocks. For example, the cluster classification part 312 may have the functions of the feature amount obtaining part 310, the cluster analysis part 311, and the action execution part 313.

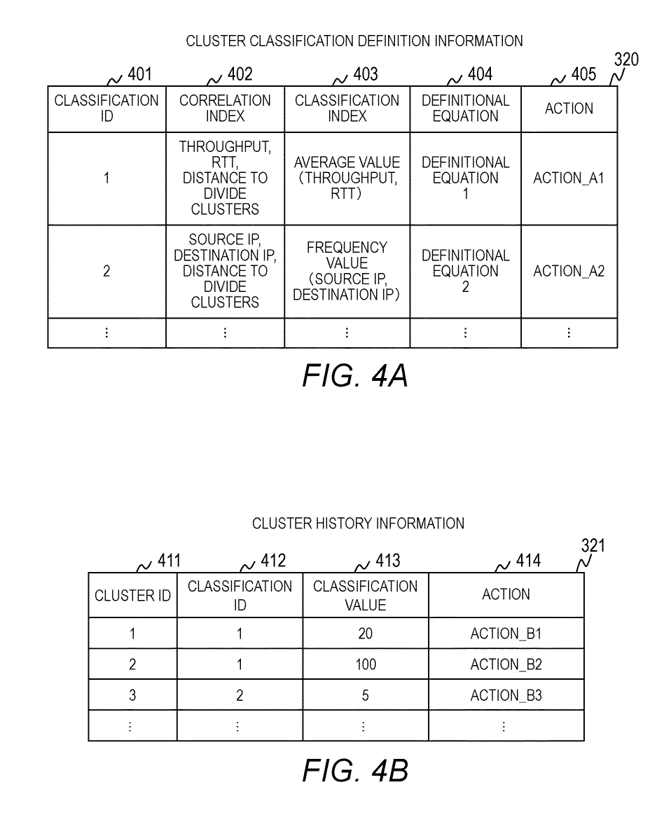

FIG. 4A is a diagram for explaining one example of the cluster classification definition information 320 managed by the analysis apparatus 100 of the first embodiment. FIG. 4B is a diagram for explaining one example of the cluster history information 321 managed by the analysis apparatus 100 of the first embodiment.

In this embodiment, the analysis apparatus 100 generates a plurality of clusters based on a plurality of algorithms having different correlations, and classifies a plurality of clusters by the types of communication. The cluster classification definition information 320 is information regarding a cluster analysis method and cluster classification method. The cluster classification definition information 320 includes one entry for each combination of the cluster analysis method and cluster classification method. Each entry includes a classification ID 401, a correlation index 402, a classification index 403, a definitional equation 404, and an action 405.

The classification ID 401 is a unique identifier for a combination of cluster analysis method and classification method. The correlation index 402 is information used for cluster analysis. Specifically, the correlation index 402 is the information indicating a combination of feature amounts for generating a plurality of clusters from a plurality of sessions. For example, in a case where the correlation index 402 has stored therein “throughput, RTT, distance to divide clusters,” the analysis apparatus 100 generates a plurality of clusters by classifying a plurality of sessions based on the correlations of the throughput and RTT. In this case, one cluster is made up of a plurality of sessions located within a distance shorter than the distance to divide clusters in the correlation graphs of throughput and RTT.

The classification index 403 and the definitional equation 404 are information used for classifying each of the plurality of clusters, i.e., information indicating the classification method. The classification index 403 indicates a type of the index used for classifying the generated clusters by the types of communication. The classification index 403 stores therein an average value, frequency, maximum value, minimum value, and the like. The definitional equation 404 is definitional equation used for classifying the plurality of clusters based on the classification index 403. The definitional equation 404 includes an equation or the like related to the classification index 403 such as the definitional equation included in the image 130 of FIG. 1. In the description below, values calculated to classify the plurality of clusters using the definitional equation 404 may also be referred to as classification values.

The action 405 is the control policy that defines the control content for each of the classified clusters. The action 405 defines the control content (action) for at least one cluster. The control content for one cluster is applied to a plurality of sessions included in the cluster. In the description below, the control content for a cluster, or in other words, operation will also be referred to as an action. In the first embodiment, it is assumed that there are actions to apply to all clusters classified based on the definitional equation 404.

The cluster history information 321 manages clusters that were not classified based on the cluster classification definition information 320. In the description below, a cluster managed by the cluster history information 321 may also be referred to as a history cluster. The cluster history information 321 includes a cluster ID 411, a classification ID 412, a classification value 413, and an action 414.

The cluster ID 411 is a unique identifier for the history cluster. The classification ID 412 is the same as the classification ID 401. The classification ID 412 indicates the classification method used in a classification by using the cluster classification definition information 320. The classification value 413 is value calculated based on the definitional equation 404 of an entry where the classification ID 401 matches the classification ID 412. The action 414 is the same as the action 405. In the first embodiment, the analysis apparatus 100 automatically sets information in the action 414 when a history cluster is registered in the cluster history information 321. The action 414 may also be set through the cluster definition updating part 315.

FIG. 5 is a diagram for explaining one example of the feature amount management information 500 managed by the analyzer 103 of the first embodiment.

The feature amount management information 500 includes a plurality of entries 501 each made up of a plurality of feature amounts of a session. The entry 501 of the first embodiment includes, as the feature amounts of a session, an ID 505, an IP1 (510), a port1 (511), a seq1 (512), an ack1 (513), a rrt1 (514), a pkt1 (515), a bit1 (516), a BW1 (517), an aveBW1 (518), a loss1 (519), a time1 (520), an IP2 (521), a port2 (522), a seq2 (523), an ack2 (524), a rrt2 (525), a pkt2 (526), a bit2 (527), a BW2 (528), an aveBW2 (529), a loss2 (530), a time2 (531), a len1 (532), a len2 (533), a syn1 (534), a syn2 (535), a fin1 (536), a fin2 (537), and a vlan 538. The entry 501 may also include other feature amounts than those mentioned here.

The ID 505 is identification information for a session. The IP1 (510) and the IP2 (521) are IP addresses of each of two terminals 110 connected via the session. The port1 (511) and the port2 (522) are port numbers of the each of two terminals 110 connected via the session.

The seq1 (512) and the seq2 (523) are transmission sequence numbers of the each of two terminals 110 connected via the session. The ack1 (513) and the ack2 (524) are reception sequence numbers of the each of two terminals 110 connected via the session.

The pkt1 (515) and the pkt2 (526) are transmission packet counts of the each of two terminals 110 connected via the session. The bit1 (516) and the bit2 (527) are transmission bit numbers of the each of two terminals 110 connected via the session. The len1 (532) and the len2 (533) are transmission packet lengths of the each of two terminals 110 connected via the session.

The BW1 (517) and the BW2 (528) are the most recent transmission bandwidths of the each of two terminals 110 connected via the session. The aveBW1 (518) and the aveBW2 (529) are the average transmission bandwidths of the each of two terminals 110 connected via the session.

The syn1 (534) and the syn2 (535) are SYN packet transmission counts of the each of two terminals 110 connected via the session. The fin1 (536) and the fin2 (537) are FIN packet transmission counts of the each of two terminals 110 connected via the session.

The rrt1 (514) and the rrt2 (525) are round-trip delay times of the each of two terminals 110 connected via the session. The loss1 (519) and the loss2 (530) are packet loss rates of the each of two terminals 110 connected via the session. The time1 (520) and the time2 (531) are communication durations of the each of two terminals 110 connected via the session.

The vlan 538 is the VLAN number used by two terminals 110 connected via the session.

FIG. 6 is a diagram for explaining one example of the feature amount history management information 600 managed by the storage apparatus 104 of the first embodiment.

The feature amount history management information 600 includes a plurality of entries 601 each made up of a plurality of feature amounts of a session. The entry 601 of the first embodiment includes, as the feature amounts of a session, an ID 605, an IP1 (610), a port1 (611), a seq1 (612), an ack1 (613), a rrt1 (614), a pkt1 (615), a bit1 (616), a BW1 (617), an aveBW1 (618), a loss1 (619), a time1 (620), an IP2 (621), a port2 (622), a seq2 (623), an ack2 (624), a rrt2 (625), a pkt2 (626), a bit2 (627), a BW2 (628), an aveBW2 (629), a loss2 (630), a time2 (631), a len1 (632), a len2 (633), a syn1 (634), a syn2 (635), a fin1 (636), a fin2 (637), a vlan 638, a freq1 (639), a freq2 (640), and a rec_time 641. The entry 601 may also include other feature amounts than those mentioned here.

Columns from the ID 605 to the vlan 638 are the same columns as those of the entry 501 of the feature amount management information 500. The seq1 (639) and thr seq2 (640) are periodicities of transmission throughput of the each of two terminals 110 connected via the session. The rec_time 641 is a recording time.

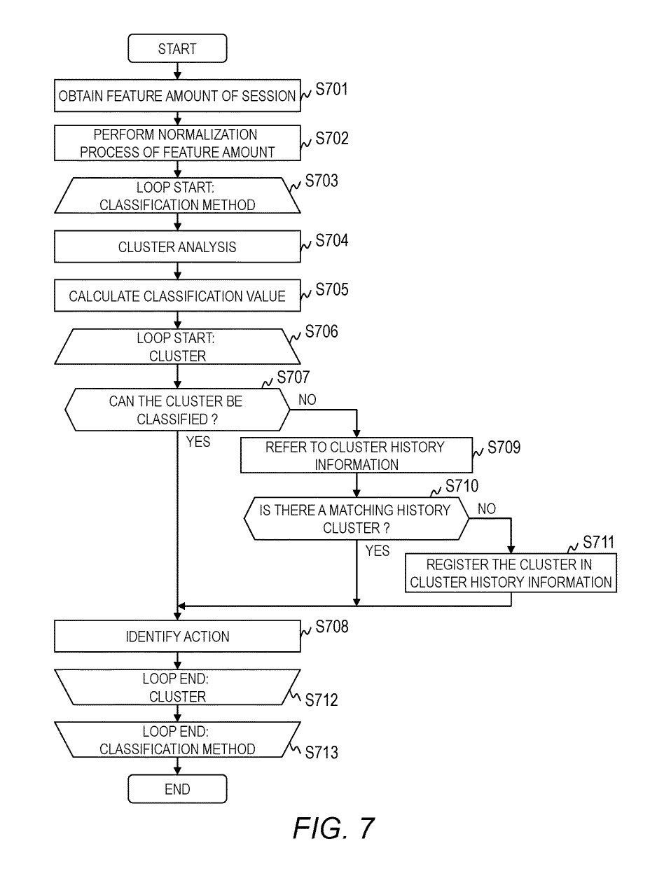

FIG. 7 is a flowchart for explaining the process performed by the analysis apparatus 100 of the first embodiment.

The analysis apparatus 100 performs the process described below periodically or upon receipt of an instruction from the administrator. However, the timing at which the process is performed is not limited to those. For example, a request to start the process may also be input into the analysis apparatus 100 when the storage apparatus 104 newly generates or updates an entry 601.

The analysis apparatus 100 first obtains feature amounts of all sessions from the storage apparatus 104 (Step S701), and performs a normalization process on the feature amounts (Step S702).

Specifically, the feature amount obtaining part 310 obtains all entries 601 stored in the feature amount history management information 600 managed by the storage apparatus 104. The feature amount obtaining part 310 performs the normalization process on prescribed feature amounts. For example, the feature amount obtaining part 310 performs a normalization process using the maximum value or average value of the transmission packet counts.

It is assumed that the feature amounts to be subjected to the normalization process are determined in advance. For example, the analysis apparatus 100 can determine the feature amounts to be subjected to the normalization process based on the definitional equation 404 of the cluster classification definition information 320. The normalization process is a known process, and is not described in detail here. The normalization process may be omitted.

Next, the analysis apparatus 100 starts the loop process of the classification method (Step S703). Specifically, the cluster analysis part 311 selects one entry from the cluster classification definition information 320.

Next, the analysis apparatus 100 performs the cluster analysis based on the entry selected from the cluster classification definition information 320 (Step S704). This way, a plurality of clusters are generated from a plurality of sessions. For example, the following processes may be performed.

The cluster analysis part 311 selects target feature amounts from the plurality of feature amounts included in one entry 601 based on the correlation index 402 of the entry selected from the cluster classification definition information 320, and generates a feature amount vector. The cluster analysis part 311 calculates the distance between the respective feature amount vectors of two sessions. In a case where the calculated distance is smaller than a prescribed threshold, the cluster analysis part 311 groups the two sessions together. The cluster analysis part 311 performs this process on every combination of all sessions. This way, a plurality of clusters are generated from a plurality of sessions.

Next, the analysis apparatus 100 calculates respective classification values of a plurality of clusters (Step S705).

Specifically, the cluster classification part 312 calculates a classification value of each cluster based on the classification index 403 of the entry selected from the cluster classification definition information 320. For example, in a case where the first entry from the top in FIG. 4A is selected, the cluster classification part 312 calculates the average value of throughput as the classification value, using the feature amounts of a plurality of sessions included in each cluster.

Next, the analysis apparatus 100 starts the loop process of the cluster (Step S706). Specifically, the cluster classification part 312 selects one target cluster from a plurality of clusters that have been generated. The analysis apparatus 100 determines whether the target cluster can be classified or not (Step S707).

Specifically, the cluster classification part 312 determines whether the target cluster can be classified or not based on the definitional equation 404 of the entry selected from the cluster classification definition information 320, and the classification value of the target cluster.

In a case where it is determined that the target cluster can be classified, the analysis apparatus 100 identifies an action to be applied to the target cluster (Step S708), and then proceeds to Step S712.

Specifically, the cluster classification part 312 identifies an action to be applied to the target cluster based on the action 405 of the entry selected from the cluster classification definition information 320.

In a case where it is determined that the target cluster cannot be classified in Step S707, the analysis apparatus 100 refers to the cluster history information 321 (Step S709), and determines whether or not there is a history cluster that matches the target cluster (Step S710). Specifically, the process described below is performed.

The cluster classification part 312 searches for an entry in which the classification ID 412 matches the classification ID 401 of the entry selected from the cluster classification definition information 320. In a case where there is no entry fulfilling this condition, the cluster classification part 312 determines that there is no history cluster that matches the target cluster.

In a case where there is an entry that fulfill the condition, the cluster classification part 312 compares the classification value 413 of the retrieved entry with the classification value of the target cluster calculated in Step S705. In a case where the classification value of the target cluster calculated in Step S705 matches the classification value 413 of the retrieved entry, or the difference between the two classification values is smaller than a prescribed threshold value, the cluster classification part 312 determines that there is a history cluster that matches the target cluster. The process of Step S710 is performed as described above.

In a case where it is determined that there is a history cluster that matches the target cluster, the analysis apparatus 100 identifies the action to be applied to the selected cluster (Step S708), and proceeds to Step S712.

Specifically, the cluster classification part 312 identifies an action to be applied to the target cluster based on the action 414 of the entry retrieved in Step S710.

In a case where it is determined that there is no history cluster that matches the target cluster, the analysis apparatus 100 registers the target cluster in the cluster history information 321 as a new history cluster (Step S711). Specifically, the process described below is performed.

The cluster classification part 312 adds an entry to the cluster history information 321, and sets an identifier to the cluster ID 411 of the added entry. The cluster classification part 312 sets the classification ID 401 of the entry selected in Step S703 to the classification ID 412 of the added entry. The cluster classification part 312 then sets the classification value calculated in Step S705 to the classification value 413 of the added entry. Additionally, the cluster classification part 312 sets prescribed action information to the action 414 of the added entry.

In this embodiment, in a case where an unknown cluster is registered in the cluster history information 321, the information of action that has been defined in advance is automatically set to the action 414. For example, information to activate an alarm is set to the action 414.

The analysis apparatus 100 does not necessarily have to automatically set the action information. For example, the analysis apparatus 100 may be configured such that the output part 314 displays a screen to set up the action 414 in the setup terminal 106 operated by the administrator.

The analysis apparatus 100 does not necessarily have to set up the action 414. In this case, the analysis apparatus 100 proceeds to Step S712 after the process of Step S710. This concludes the description of the process of Step S711.

After registering information on the new history cluster in the cluster history information 321, the analysis apparatus 100 identifies an action for the cluster (Step S708), and proceeds to Step S712.

Specifically, the cluster classification part 312 identifies an action to be applied to the target cluster based on the action 414 of the entry newly added to the cluster history information 321.

After identifying the action for the target cluster, the analysis apparatus 100 determines whether all of the generated clusters have been processed or not (Step S712).

In a case where all of the generated clusters have not yet been processed, the analysis apparatus 100 returns to Step S706, and the processes described above are repeated.

In a case where all of the generated clusters have been processed, the analysis apparatus 100 determines whether all of the analysis methods have been processed or not (Step S713).

In a case where all of the analysis methods have not yet been processed, the analysis apparatus 100 returns to Step S703, and the processes described above are repeated.

In a case where all of the analysis methods have been processed, the analysis apparatus 100 ends the process. The analysis apparatus 100 may also be configured to output the classification results to a different device such as the output device 105 and the like, after the cluster classification is finished. In this case, the different device identifies an action to be applied to each of the plurality of clusters based on the classification results.

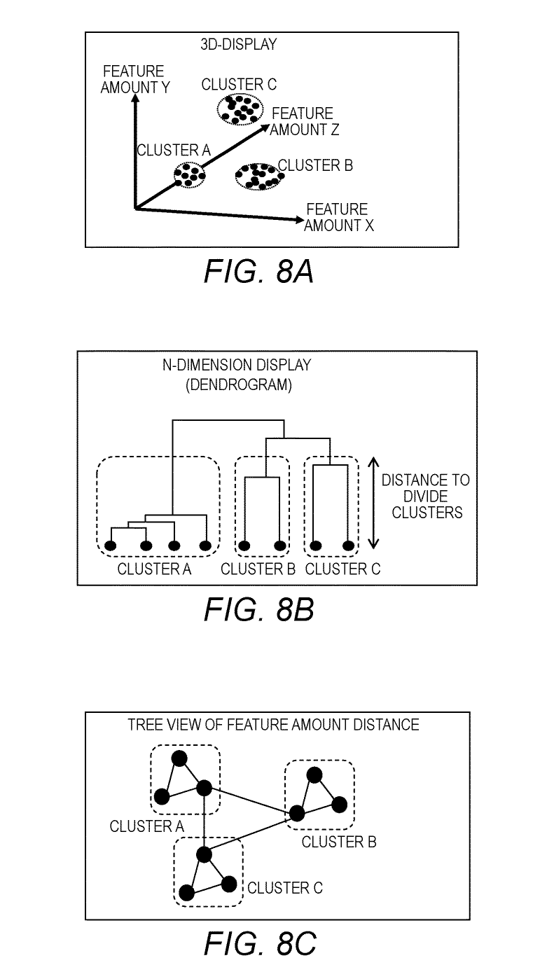

FIGS. 8A, 8B, and 8C are diagrams each showing a display example of the clusters output by the output part 314 of the first embodiment.

FIG. 8A is a display example of clusters using the N-dimensional display. FIG. 8B is a display example of clusters using the dendrogram. FIG. 8C is a display example of clusters using the tree view. The dots included in the clusters may be displayed in different colors such as red, blue, and green to indicate respective the clusters. The distance to divide clusters may also be displayed. The cluster display method is not limited to the examples of this embodiment.

The analysis apparatus 100 of the first embodiment generates a plurality of clusters from a plurality of sessions, and analyzes each cluster using at least one feature amount of the plurality of sessions included in each cluster. The analysis apparatus 100 then classifies the plurality of clusters by the communication types based on the analysis results. By performing the analysis of the cluster unit, it is possible to classify communications without being affected by a change in feature amounts in each session, statistical distribution, and the like.

The analysis apparatus 100 also determines the control policy (action) for controlling the sessions included in each cluster after classification. That is, the analysis apparatus 100 executes unsupervised learning based on the correlation, thereby generating clusters from a plurality of sessions having similar tendencies in feature amounts, classifying a plurality of clusters by the communication types, and setting the control policy for each cluster based on the classification results. This way, it is possible to determine the control policy for sessions without being affected by a change in feature amounts in each session, statistical distribution, and the like. Because the sessions are controlled by the cluster unit, the consistent control policy can be set for the respective sessions.

The analysis apparatus 100 manages clusters that cannot be classified as history clusters, which makes it possible to detect communication having unknown feature amounts and to classify communication based on the history clusters.

In the first embodiment, TCP session has been explained as an example, but the present invention is not limited to this. By using feature amounts corresponding to algorithm, various types of communication flow can be classified in a similar manner, and the communication flow can be controlled based on the classification results.

In the first embodiment, the analysis apparatus 100 is configured as one apparatus, but the present invention is not limited to this. For example, the communication apparatus 101, the transfer apparatus 102, the analyzer 103, or the storage apparatus 104 may be configured to have an analysis part that realizes the function similar to that of the analysis apparatus 100. The analysis part is realized by the arithmetic device included in the communication apparatus 101 or the like executing a prescribed program stored in the main storage device.

### Second Embodiment

The second embodiment differs from the first embodiment in that the cluster classification definition information 320 and the cluster history information 321 include clusters that have no action applied thereto. The second embodiment also differs from the first embodiment in that the analysis apparatus 100 executes an identified action. Below, the second embodiment will be explained, mainly focusing on the differences from the first embodiment.

The configuration of the network system and the analysis apparatus 100 of the second embodiment are the same as those of the first embodiment. The configurations of the packet, cluster classification definition information 320, and cluster history information 321 of the second embodiment are the same as those of the first embodiment. However, the action 405 and the action 414 differ from those of the first embodiment.

For example, in the action 405 of at least one entry of the cluster classification definition information 320 of the second embodiment, is set the action information is applied to only some of the clusters, or is blank. Also, in the second embodiment, the action 414 of at least one entry of the cluster history information 321 is blank.

The feature amount management information 500 and the feature amount history management information 600 of the second embodiment are the same as those of the first embodiment.

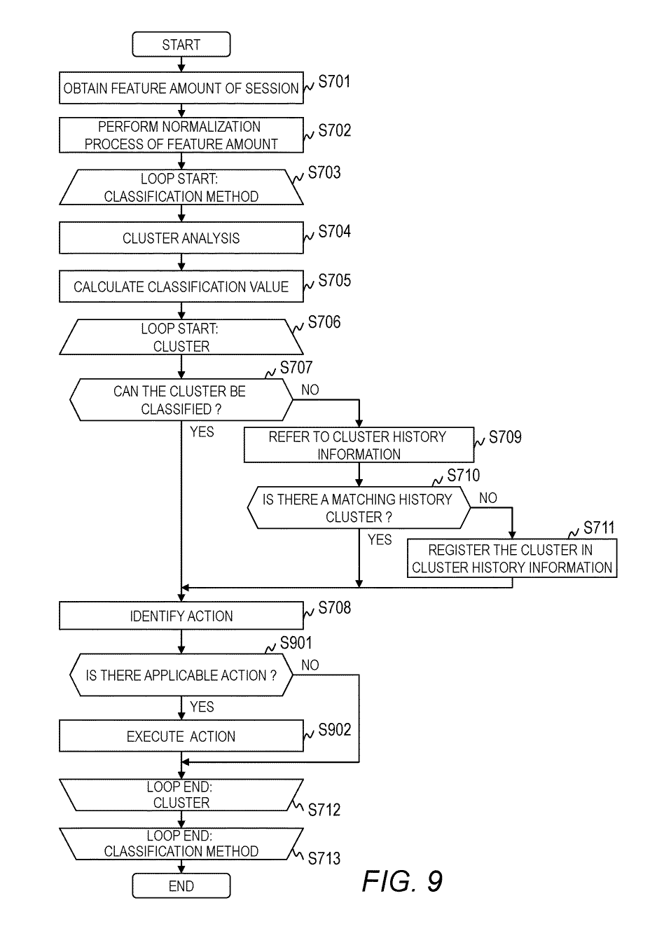

In the second embodiment, the process of the analysis apparatus 100 partially differs from that of the first embodiment. FIG. 9 is a flowchart for explaining the process performed by the analysis apparatus 100 of the second embodiment.

The processes from Step S701 to Step S711 are the same as those of the first embodiment.

After the result of Step S707 is YES and the process of Step S708 is performed, the analysis apparatus 100 determines whether there is an action that can be applied to the target cluster or not (Step S901).

Specifically, the cluster classification part 312 refers to the action 405 of the selected entry, and determines whether an action to be applied to the target cluster is set in the action 405 or not.

After the result of Step S710 is YES and the process of Step S708 is performed, the analysis apparatus 100 determines whether there is an action that can be applied to the target cluster or not (Step S901).

Specifically, the cluster classification part 312 refers to the action 414 of the retrieved entry, and determines whether an action to be applied to the target cluster is set in the action 414 or not.

After the processes of Step S711 and Step S708 are performed, the analysis apparatus 100 determines whether there is an action that can be applied to the target cluster or not (Step S901).

Specifically, the cluster classification part 312 refers to the action 414 of the entry newly added to the cluster history information 321, and determines whether an action to be applied to the target cluster is set in the action 414 or not.

In a case where it is determined that there is an action that can be applied to the target cluster in Step S901, the analysis apparatus 100 executes the action (Step S902). Then the analysis apparatus 100 proceeds to Step S712.

Specifically, the cluster classification part 312 outputs information on the action identified in Step S708 to the action execution part 313. The action execution part 313 executes a prescribed action based on the action information that has been output. The action execution part 313 outputs to the output part 314 necessary information for the action to be executed.

In a case where it is determined that an action that can be applied to the target cluster does not exist in Step S901, the analysis apparatus 100 proceeds to Step S712.

The analysis apparatus 100 of the second embodiment can generate a plurality of clusters from a plurality of sessions, and determine the control policy (action) for controlling the sessions in each cluster. The analysis apparatus 100 controls a plurality of sessions included in each cluster based on the determined control policy.

This way, it is possible to control sessions without being affected by a change in feature amounts in each session, statistical distribution, and the like. Because the sessions are controlled by the cluster unit, respective sessions can be consistently controlled.

### Third Embodiment

In the third embodiment, the specific process of the analysis apparatus 100 will be explained using the detection of DDoS attack as an example. The configurations of the network system and analysis apparatus 100 of the third embodiment are the same as those of the first embodiment, and the information managed by the analysis apparatus 100, the analyzer 103, and the storage apparatus 104 of the third embodiment are the same as those of the first embodiment.

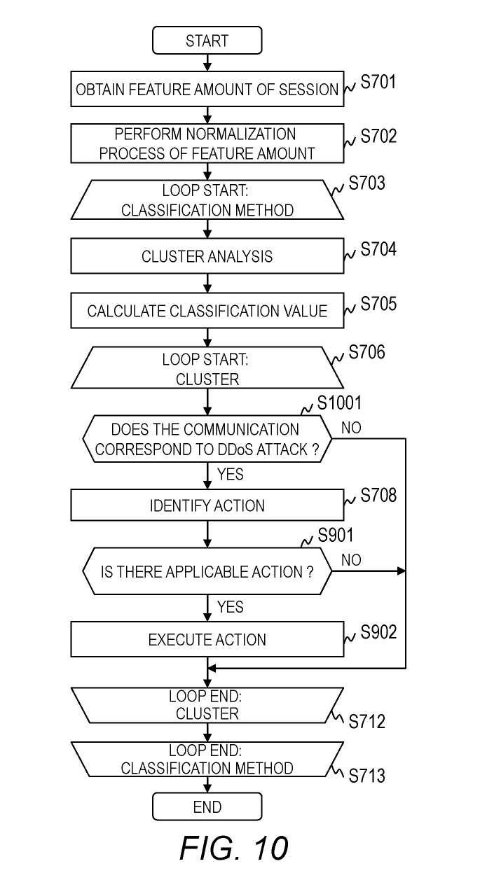

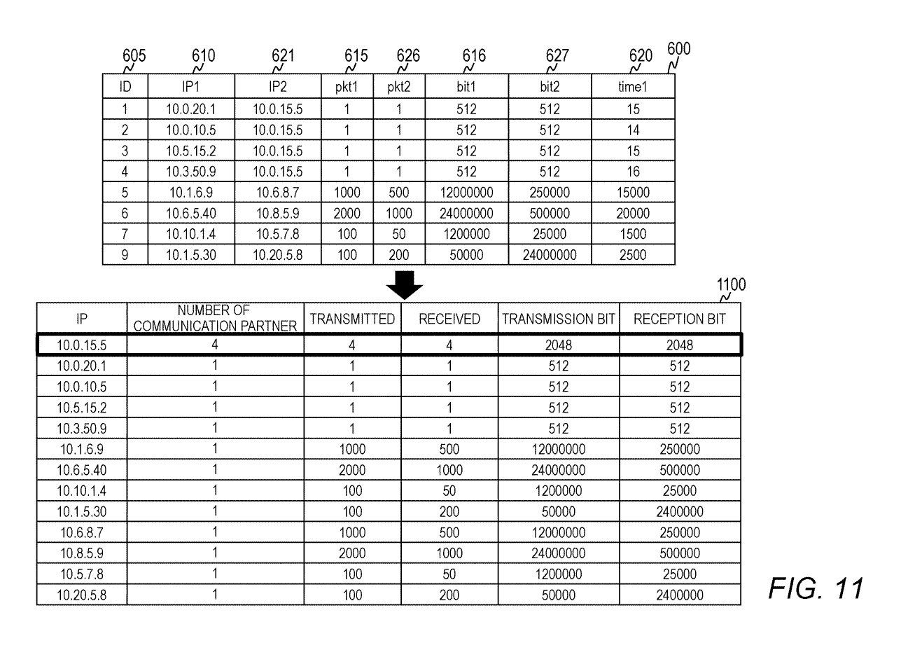

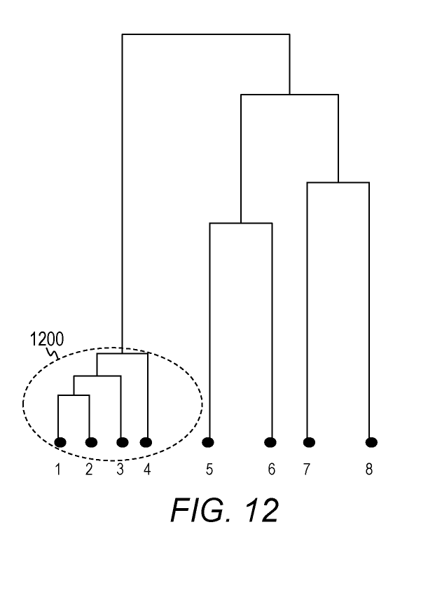

FIG. 10 is a flowchart for explaining an example of the process performed by the analysis apparatus 100 of the third embodiment in order to detect DDoS attack. FIG. 11 is a diagram for explaining one example of the feature amount history management information 600 of the third embodiment. For convenience, only a part of the columns of the feature amount history management information 600 is displayed in the third embodiment. FIG. 12 is a diagram showing an example of the process results of cluster analysis in the third embodiment,

The processes of Steps S701, S702, S706, S708, and S712 are the same as those of the first embodiment, and the processes of Steps S901 and S902 are the same as those of the second embodiment. Examples of the cluster action addressing the DDoS attack include enabling an appropriate function such as an Intrusion Detection System (IDS) or an Intrusion Prevention System (IPS).

In Step S703 of the third embodiment, the analysis apparatus 100 selects the analysis method that uses the transmitted and received packet counts, transmission bit number, reception bit number, source IP address, and destination IP address. In Step S704 of the third embodiment, the analysis apparatus 100 calculates an average value of the transmitted and received packet counts, an average value of the transmission bit number, an average value of the reception bit number, a variance of the source IP address, and a variance of the destination IP address.

In Step S706, after the target cluster is selected, the analysis apparatus 100 determines whether the communication of sessions included in the target cluster corresponds to DDoS attack or not (Step S1001).

Specifically, the cluster classification part 312 determines whether the average value of the transmitted and received packet counts is “1” or not, whether the average value of the transmission bit number and the reception bit number are “512” or not, whether the variance of the source IP is equal to or larger that a prescribed threshold or not, and whether the variance of the destination IP is equal to or smaller than a prescribed threshold or not. This way, it is possible to identify the communication group (cluster) that corresponds to DDoS attack.

As shown in FIG. 11, the conventional apparatus is configured to detect communication that corresponds to DDoS attack by generating feature amount information 1100 for each IP address generated from the feature amount history management information 600, and referring to the entry to extract an IP address having a large number of communication partners and small transmission and reception bit numbers. The entry enclosed by the bold frame in the feature amount information 1100 corresponds to the DDoS attack.

On the other hand, as shown in FIG. 12, the analysis apparatus 100 performs cluster analysis using the feature amount history management information 600, thereby grouping a plurality of sessions within the broken line 1200 together as one cluster in the dendrogram 1101. The analysis apparatus 100 identifies a cluster in which the average value of the pkt1 (615) and the pkt2 (626) are “1,” the average value of the bit1 (616) and the bit2 (627) are “512,” the variance of IP2 (621) is equal to or smaller than a prescribed threshold, and the variance of IP1 (610) is equal to or larger than a prescribed threshold as a cluster corresponding to the DDoS attack.

In the third embodiment, the analysis apparatus 100 can directly extract a session group related to DDoS attack, and control the respective sessions in the group consistently.

### Fourth Embodiment

In the fourth embodiment, the specific process of the analysis apparatus 100 will be explained using the detection of anomalous communication as an example. The configurations of the network system and analysis apparatus 100 of the fourth embodiment are the same as those of the first embodiment, and the information managed by the analysis apparatus 100, the analyzer 103, and the storage apparatus 104 of the fourth embodiment are the same as those of the first embodiment.

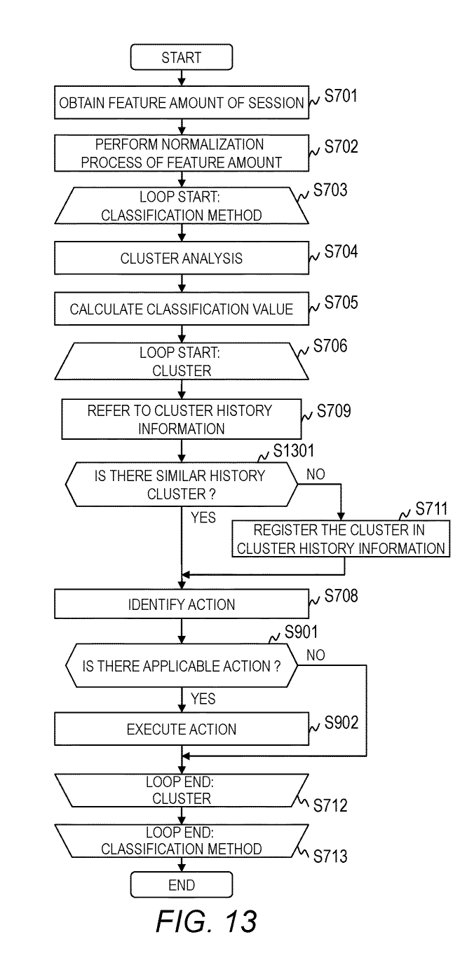

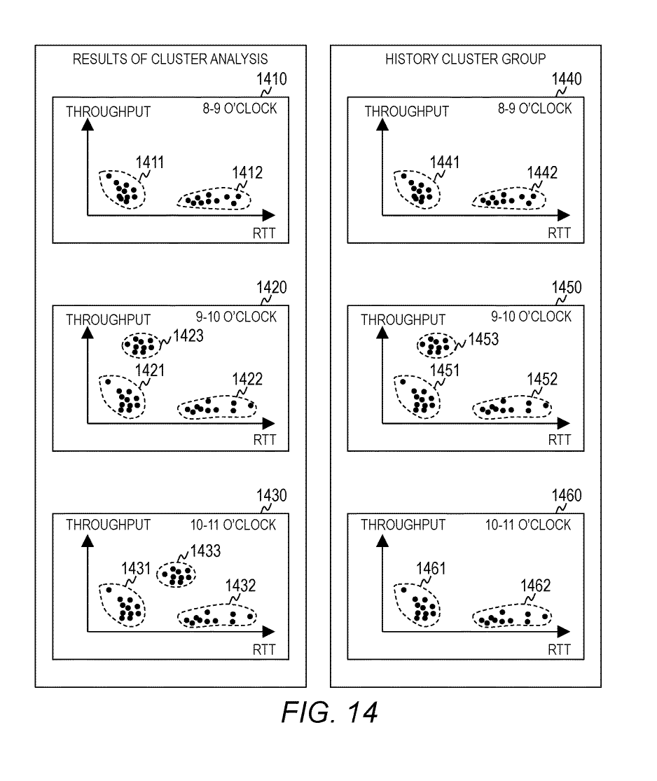

FIG. 13 is a flowchart for explaining an example of the process performed by the analysis apparatus 100 of the fourth embodiment in order to detect anomalous communication.

The analysis apparatus 100 performs cluster analysis on a plurality of sessions within a prescribed time range, thereby generating a plurality of clusters, and detects anomalous communication by comparing each of the plurality of clusters with the history cluster. In this case, the definitional equation of the cluster classification definition information 320 has stored therein the information that instructs the comparison with the history cluster. In a case where a cluster that does not match or is not similar to the history cluster is detected, the analysis apparatus 100 detects such a cluster as a session group that corresponds to anomalous communication.

The classification value 413 of the cluster history information 321 of the fourth embodiment includes time information determined based on the rec_time 641 of each session.

The processes of Steps S701, S702, S706, S708, and S712 are the same as those of the first embodiment, and the processes of Steps S901 and S902 are the same as those of the second embodiment. Examples of the action applied to the cluster that corresponds to anomalous communication include sending an alarm.

In Step S703 of the fourth embodiment, the analysis apparatus 100 selects the analysis method using RTT and throughput. In Step S704 of the fourth embodiment, the analysis apparatus 100 divides the rec_time 641 by hour, and performs cluster analysis on a plurality of sessions of each hour, thereby generating a plurality of clusters. For example, the analysis apparatus 100 performs cluster analysis based on the feature amount information of the sessions in a range from 8 am to 9 am of the rec_time 641. In Step S705, the analysis apparatus 100 calculates the average value of RTT and the average value of throughput in each cluster. The analysis apparatus 100 gives time information to each cluster.

In the fourth embodiment, the definitional equation 404 includes information that instructs the comparison with the history cluster, and therefore, the same process would be performed in Step S707 and Step S710. Thus, after the process of Step S706, the analysis apparatus 100 refers to the cluster history information 321 (Step S709), and determines whether a similar history cluster exists or not (Step S1301). Specifically, the process described below is performed.

The cluster classification part 312 searches for an entry in which the classification ID 412 matches the classification ID 401 of the entry selected from the cluster classification definition information 320. In a case where there is no entry fulfilling this condition, the cluster classification part 312 determines that there is no matching history cluster.

In a case where there is an entry that fulfill the condition, the cluster classification part 312 determines whether or not the time information included in the classification value 413 of the searched entry matches the time information on the cluster selected in Step S706. In a case where the time information included in the classification value 413 does not match the time information on the selected cluster, the cluster classification part 312 searches for another entry. If no entry exists, the cluster classification part 312 determines that there is no matching history cluster.

In a case where the time information included in the classification value 413 matches the time information of the selected cluster, the cluster classification part 312 compares the combination of the average value of RTT and the average value of throughput, which were calculated in Step S705, with the values included in the classification value 413. In this example, the cluster classification part 312 calculates the distance on the plane between the two feature amounts, which builds RTT and throughput.

In a case where the distance between the combination of the average value of RTT and the average value of throughput and the value included in the classification value 413 is equal to or smaller than a prescribed threshold, the cluster classification part 312 determines that there is a matching history cluster. The processes of Step S709 and Step S1301 are performed as described above.

In a case where it is determined that a similar history cluster exists, the analysis apparatus 100 proceeds to Step S708. On the other hand, in a case where it is determined that a similar history cluster does not exist, the analysis apparatus 100 registers the selected cluster in the cluster history information 321 (Step S711). In this process, the classification value calculated in Step S705 and the time information of the target cluster are set to the classification value 413.

After the target cluster is registered in the cluster history information 321, in Step S708, the analysis apparatus 100 identifies this cluster as a cluster corresponding to anomalous communication, and identifies an action for this cluster.

FIG. 14 is a diagram for explaining an example of anomalous communication detection in the fourth embodiment.

In FIG. 14, the left frame shows the cluster analysis results, and the right frame shows the history clusters registered in the cluster history information 321.

In Step S704, the analysis apparatus 100 performs cluster analysis using entries 601 within a time range from 8 am to 9 am of the rec_time 641, and outputs the results 1410.

In Step S709, the analysis apparatus 100 refers to a history cluster group 1440 where the classification value 413 is “8 am to 9 am,” and compares the results 1410 with the history cluster group 1440. In this case, the analysis apparatus 100 determines that there is a history cluster 1441 similar to the cluster 1411, and that there is a history cluster 1442 similar to the cluster 1412.

In Step S704, the analysis apparatus 100 performs cluster analysis using entries 601 within a time range from 9 am to 10 am of the rec_time 641, and outputs the results 1420.

In Step S709, the analysis apparatus 100 refers to a history cluster group 1450 where the classification value 413 is “9 am to 10 am,” and compares the results 1420 with the history cluster group 1450. In this case, the analysis apparatus 100 determines that a history cluster 1451 similar to the cluster 1421, a history cluster 1452 similar to the cluster 1422, and a history cluster 1453 similar to the cluster 1423 respectively exist.

In Step S704, the analysis apparatus 100 performs cluster analysis using entries 601 within a time range from 10 am to 11 am of the rec_time 641, and outputs the results 1430.

In Step S709, the analysis apparatus 100 refers to a history cluster group 1460 where the classification value 413 is “10 am to 11 am,” and compares the results 1430 with the history cluster group 1460. In this case, the analysis apparatus 100 determines that a history cluster 1461 similar to the cluster 1431, and a history cluster 1462 similar to the cluster 1432 respectively exist. On the other hand, the analysis apparatus 100 determines that a history cluster similar to the cluster 1433 does not exist, and registers the cluster 1433 in the cluster history information 321 as a history cluster.

In the fourth embodiment, the analysis apparatus 100 can directly extract a communication group (cluster) that corresponds to anomalous communication based on the history cluster, and can control the respective sessions included in the cluster consistently.

### Fifth Embodiment

In the fifth embodiment, the specific process of the analysis apparatus 100 will be explained using the detection of degradation in communication quality as an example. The configurations of the network system and analysis apparatus 100 of the fifth embodiment are the same as those of the first embodiment, and the information managed by the analysis apparatus 100, the analyzer 103, and the storage apparatus 104 of the fifth embodiment are the same as those of the first embodiment.

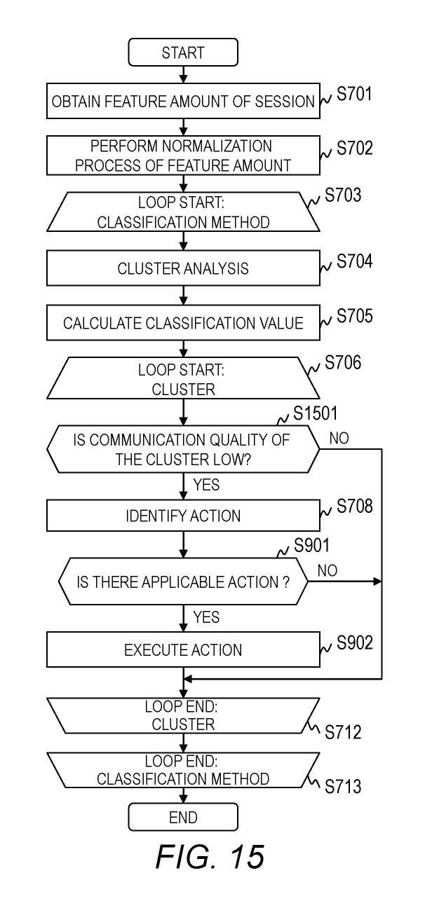

FIG. 15 is a flowchart for explaining an example of the process performed by the analysis apparatus 100 of the fifth embodiment in order to detect degradation in communication quality.

The processes of Steps S701, S702, S706, S708, S712, and S713 are the same as those of the first embodiment, and the processes of Steps S901 and S902 are the same as those of the second embodiment. Examples of the action applied to the sessions included in a cluster that has low communication quality include a communication speed improvement service.

In Step S703 of the fifth embodiment, the analysis apparatus 100 selects the analysis method in which the correlation index 402 includes RTT and packet loss rate, and the classification index 403 includes the average values of the packet loss rates, RTT, and throughput of the respective communication locations. In Step S704 of the fifth embodiment, the analysis apparatus 100 performs cluster analysis based on the packet loss rate and the average value RTT, thereby generating a plurality of clusters. In the fifth embodiment, one cluster is generated for one location. In Step S705, the analysis apparatus 100 calculates the average value of the packet loss rates and the RTT of the respective clusters, and the throughput of the respective clusters.

After the target cluster is selected in Step 706, the analysis apparatus 100 determines whether the target cluster is a cluster having low communication quality or not. (Step S1501).

Specifically, the cluster classification part 312 determines whether the average value of the packet loss rates is larger than a prescribed threshold or not, whether the average value of RTT is larger than a prescribed threshold or not, and whether the throughput is smaller than a threshold or not. The analysis apparatus 100 detects a cluster fulfilling those conditions as a cluster with low communication quality.

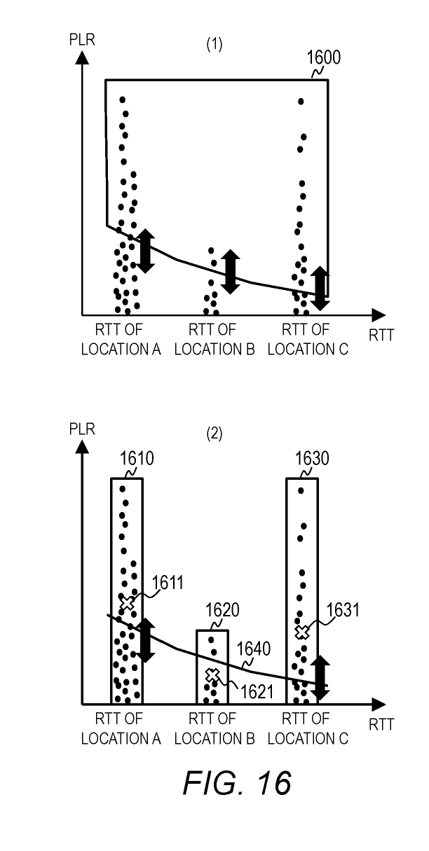

FIG. 16 is a diagram for explaining an example of detecting degradation in communication quality in the fifth embodiment. This figure shows a case in which communications of three locations A, B, and C having different RTT are analyzed.

FIG. 16 (1) shows an example of detecting degradation in communication quality in the conventional configuration. FIG. 16 (2) shows an example of detecting degradation in communication quality in the fifth embodiment.

As shown in (1), in the conventional configuration, an apparatus compares the RTT and the packet loss rate (PLR) of each session (each dot) with respective thresholds. If the respective values of the RTT and the PLR are larger than thresholds, the apparatus determines that the communication quality of the session is degrading, or in other words, that the communication quality is low. For example, the communication quality of the sessions in the range 1600 of (1) is low. Even in the communications of the same location, the PLR of the respective sessions varies greatly, and therefore, the communication speed improvement service is turned on and off frequently. This results in unstable communication.

On the other hand, as shown in (2), the analysis apparatus 100 of the fifth embodiment generates clusters 1610, 1620, and 1630 for each the RTT of the respective locations. The analysis apparatus 100 calculates a centroid 1611 that is the combination of the average values of PLR and RTT of the cluster 1610 including communications of the location A, a centroid 1621 that is the combination of the average values of PLR and RTT of the cluster 1620 including communications of the location B, and a centroid 1631 that is the combination of the average values of PLR and RTT of the cluster 1630 including communications of the location C. The analysis apparatus 100 determines whether it is necessary to apply the communication speed improvement service or not based on the logical throughput calculated from the centroids 1611, 1621, and 1631. The curve 1640 is a definitional equation in which the RTT and the PLR are variables.

In the fifth embodiment, it is possible to determine whether the communication speed improvement service is necessary or not collectively for the sessions having the same or similar RTT values, that is, the sessions of the same location. This results in stable communication.

### Sixth Embodiment

In the sixth embodiment, the specific process of the analysis apparatus 100 will be explained using the detection of preferences of each user as an example. The configurations of the network system and analysis apparatus 100 of the sixth embodiment are the same as those of the first embodiment. The information managed by the analysis apparatus 100, the analyzer 103, and the storage apparatus 104 of the sixth embodiment are the same as those of the first embodiment.

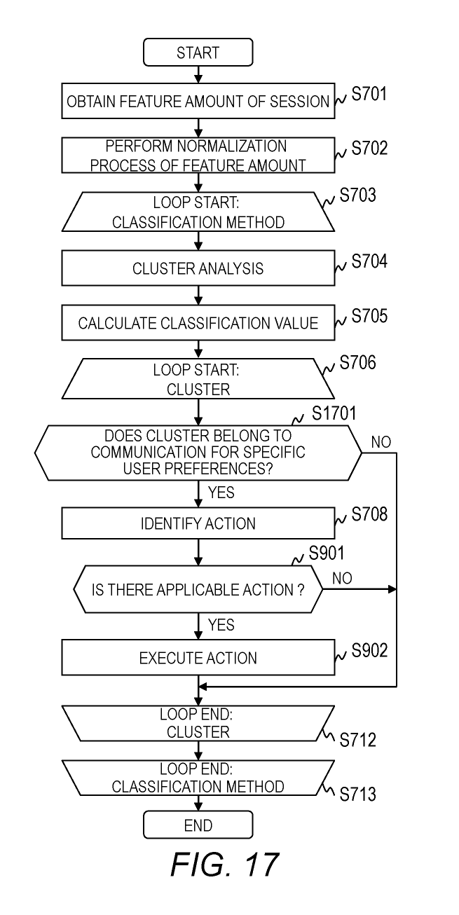

FIG. 17 is a flowchart for explaining an example of the process performed by the analysis apparatus 100 of the sixth embodiment in order to detect the preferences of each user.

The processes of Steps S701, S702, S706, S708, S712, and S713 are the same as those of the first embodiment, and the processes of Steps S901 and S902 are the same as those of the second embodiment. Examples of the action to be applied include various types of control depending on the type of communication to which the cluster belongs.

In Step S703, the analysis apparatus 100 selects the analysis method in which the correlation index 402 includes the source IP address and the destination IP address, and the classification index 403 includes download counts and upload counts for each combination of source IP address and destination IP address. In Step S704 of the sixth embodiment, the analysis apparatus 100 performs cluster analysis based on the source IP address, thereby generating a plurality of clusters. In Step S705, the analysis apparatus 100 calculates the download counts, the upload counts, and the like of the destination IP address for each cluster.

In Step S706, after the target cluster is selected, the analysis apparatus 100 determines whether the target cluster is a cluster that belongs to the communication related to prescribed user preferences or not. (Step S1701).

For example, the analysis apparatus 100 determines whether or not the cluster has a large number of downloads from a specific destination IP address, or whether or not the cluster has a large number of uploads to a specific destination IP address. The analysis apparatus 100 also determines whether the cluster frequently communicates with a specific destination IP address or not.

In a case where the cluster has a large number of downloads from a specific destination IP address, then that means the user having the IP address corresponding to the cluster is highly interested in a specific website. In a case where the cluster has a large number of uploads to a specific destination IP address, then that means the user having the IP address corresponding to the cluster frequently pushes data to a specific SNS website.

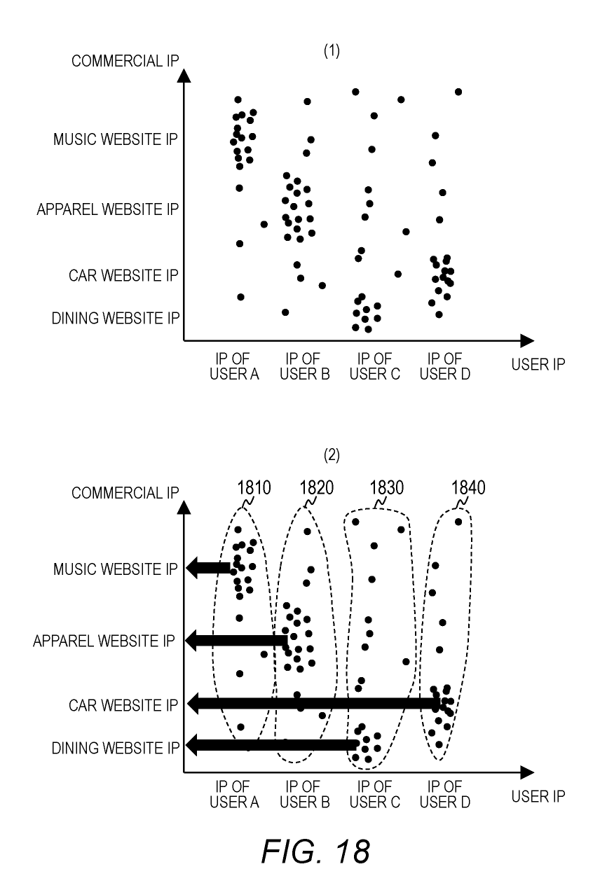

FIG. 18 is a diagram for explaining an example of detecting preferences of each user in the sixth embodiment.

FIG. 18 (1) shows an example of detecting user preferences in the conventional configuration. FIG. 18 (2) shows an example of detecting user preferences in the sixth embodiment.

As shown in (1), in the conventional configuration, an apparatus detects a destination IP address (commercial IP address) of the communication in each session (each dot). Even when the source IP address is the same, if the destination IP addresses differ, preferences of a user using the respective sessions differ. Thus, it is not possible to perform consistent control on each user.

On the other hand, as shown in (2), the analysis apparatus 100 of the sixth embodiment generates clusters 1810, 1820, 1830, and 1840 for each IP address of the user. The analysis apparatus 100 detects user preferences based on the frequency of the destination IP address in each cluster. For example, the user A corresponding to the cluster 1810 has accessed all of the music website, apparel website, car website, and dining website, and visited the music website more frequently than any other websites. This means that the characteristic of the cluster 1810 is music, that is, music is the preference of the user A.

In the sixth embodiment, it is possible to identify the user preferences, and consistent control that is appropriate for the identified preferences can be performed. In the sixth embodiment, the cluster classification is performed using IP addresses, but it is also possible to use MAC address and the like.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing (operating) modules, and processing (operation) means, for all or a part of them, may be implemented by hardware: for example, by designing an integrated circuit.

The above-described configurations and functions may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings shows control lines and information lines as considered necessary for explanation but do not show all control lines or information lines in the products. It can be considered that almost of all components are actually interconnected.

What is claimed is:

1. A network system comprising a plurality of communication apparatuses configured to control communications between a plurality of terminals that are coupled via a network,
wherein each of the plurality of communication apparatuses includes an arithmetic device, and a storage device coupled to the arithmetic device,
wherein the network system includes an analysis part for analyzing a communication flow that is a control unit for the communication between the plurality of terminals to classify a plurality of communication flows by communication types,
wherein the analysis part is realized by the arithmetic device included in at least one of the plurality of communication apparatuses executing a program stored in the storage device, and
wherein the analysis part includes:
a feature amount obtaining part that obtains, for each of the plurality of communication flows, management information on the communication flow including a plurality of feature amounts;
a cluster analysis part that analyzes the management information on the communication flow to generate a plurality of clusters each made up of the plurality of communication flows; and
a cluster classification part that classifies the plurality of clusters by communication types based on an analysis result obtained using at least one of the plurality of feature amounts of the plurality of communication flows included in each of the plurality of clusters.

2. The network system according to claim 1,
wherein the analysis part manages cluster classification definition information that includes a plurality of entries each including first information and second information, the first information indicating a generation method of the plurality of clusters, the second information indicating a classification method of the plurality of clusters,
wherein the cluster analysis part is configured to:
select one of the plurality of entries from the cluster classification definition information; and
generate the plurality of clusters from the plurality of communication flows based on the first information included in the selected entry, and
wherein the cluster classification part is configured to:
analyze the plurality of clusters based on the second information included in the selected entry to calculate a plurality of classification values of the plurality of clusters; and
classify the plurality of clusters based on the plurality of calculated classification values.

3. The network system according to claim 2,
wherein each of the plurality of entries included in the cluster classification definition information further includes third information indicating a control policy that defines an action to be applied to the cluster, and
wherein the cluster classification part is configured to determine an action to be applied to each of the plurality of classified clusters based on the third information included in the selected entry.

4. The network system according to claim 3,
wherein the analysis part further includes an execution part for determining whether there is an applicable action for each of the plurality of classified clusters based on the third information included in the selected entry, and applying the applicable action to a classified cluster in a case where there is the applicable action for the classified cluster.

5. The network system according to claim 2,
wherein the analysis part manages cluster history information that stores therein information on a history cluster, the history cluster being cluster that is not able to be classified based on the cluster classification definition information,
wherein the cluster history information includes a plurality of entries each including identification information of the history cluster, identification information of an entry included in the cluster classification definition information that is selected to classify the history cluster, a classification value of the history cluster, and a control policy that defines an action to be applied to the history cluster, and
wherein the cluster classification part is configured to:
select a target cluster from the plurality of generated clusters after being calculated the classification value of each of the plurality of clusters;
determine whether the target cluster can be classified based on the classification value of the target cluster;
refer to the cluster history information to determine whether there is the history cluster that matches the target cluster in a case where it is determined that the target cluster cannot be classified; and
determine an action to be applied to the target cluster based on the control policy corresponding to the history cluster that matches the target cluster in a case where it is determined that there is the history cluster that matches the target cluster.

6. The network system according to claim 5,
wherein the cluster classification part is configured to register the target cluster in the cluster history information as a new history cluster in a case where it is determined that there is not the history cluster that matches the target cluster.

7. A communication analysis method in a network system,
the network system including a plurality of communication apparatuses configured to control communications between a plurality of terminals that are coupled via network,
each of the plurality of communication apparatuses including an arithmetic device and a storage device coupled to the arithmetic device,
the network system including an analysis part for analyzing a communication flow that is a control unit for communication between the plurality of terminals to classify a plurality of communication flows by communication types,
the analysis part being realized by the arithmetic device included in at least one of the plurality of communication apparatuses executing a program stored in the storage device,
the communication analysis method including:
a first step of obtaining, by the analysis part, for each of the plurality of communication flows, management information on the communication flow including a plurality of feature amounts;
a second step of analyzing, by the analysis part, the management information on the communication flow to generate a plurality of clusters each made up of the plurality of communication flows; and
a third step of classifying, by the analysis part, the plurality of clusters by communication types based on an analysis result obtained using at least one of the plurality of feature amounts of the plurality of communication flows included in each of the plurality of clusters.

8. The communication analysis method according to claim 7,
wherein the analysis part manages cluster classification definition information that includes a plurality of entries each including first information and second information, the first information indicating a generation method of the plurality of clusters, the second information indicating a classification method of the plurality of clusters,
wherein the first step includes steps of:
selecting, by the analysis part, one of the plurality of entries from the cluster classification definition information; and
generating, by the analysis part, the plurality of clusters from the plurality of communication flows based on the first information included in the selected entry, and
wherein the third step includes steps of:
analyzing, by the analysis part, the plurality of clusters based on the second information included in the selected entry to calculate a plurality of classification values of the plurality of clusters; and
classifying, by the analysis part, the plurality of clusters based on the plurality of calculated classification values.

9. The communication analysis method according to claim 8,
wherein each of the plurality of entries included in the cluster classification definition information further includes third information indicating a control policy that defines an action to be applied to the cluster, and
wherein the third step includes a step of determining, by the analysis part, an action to be applied to each of the plurality of classified clusters based on the third information included in the selected entry.

10. The communication analysis method according to claim 9, further including steps of:
determining, by the analysis part, whether there is an applicable action for each of the classified plurality of clusters, based on the third information included in the selected entry; and
applying the applicable action to a classified cluster in a case where there is the applicable action for the classified cluster.

11. The communication analysis method according to claim 8,
wherein the analysis part manages cluster history information that stores therein information on a history cluster, the history cluster being a cluster that is not able to be classified based on the cluster classification definition information,
wherein the cluster history information includes a plurality of entries each including identification information of the history cluster, identification information of an entry included in the cluster classification definition information that is selected to classify the history cluster, a classification value of the history cluster, and a control policy that defines an action to be applied to the history cluster, and
wherein the third step includes steps of:
selecting, by the analysis part, a target cluster from the plurality of generated clusters after being calculated the classification value of each of the plurality of clusters;
determining, by the analysis part, whether the target cluster can be classified based on the classification value of the target cluster;
referring, by the analysis part, to the cluster history information to determine whether there is the history cluster that matches the target cluster in a case where it is determined that the target cluster cannot be classified; and
determining, by the analysis part, an action to be applied to the target cluster based on the control policy corresponding to the history cluster that matches the target cluster in a case where it is determined that there is the history cluster that matches the target cluster.

12. The communication analysis method according to claim 11, further including a step of registering, by the analysis part, the target cluster in the cluster history information as a new history cluster in a case where it is determined that there is not the history cluster that matches the target cluster.

13. An analysis apparatus configured to analyze a communication flow that is a control unit of communications between a plurality of terminals that are coupled via a network, the analysis apparatus comprising:
an arithmetic device;
a storage device coupled to the arithmetic device;
a feature amount obtaining part for obtaining, for each of a plurality of communication flows, management information on the communication flow that includes a plurality of feature amounts;
a cluster analysis part for analyzing the management information on the communication flow to generate a plurality of clusters each made up of the plurality of communication flows; and
a cluster classification part for classifying the plurality of clusters by communication types based on an analysis result obtained using at least one of the plurality of feature amounts of the plurality of communication flows included in each of the plurality of clusters.

14. The analysis apparatus according to claim 13,
wherein the analysis apparatus is configured to manage cluster classification definition information that includes a plurality of entries each including first information and second information, the first information indicating a generation method of the plurality of clusters, the second information indicating a classification method of the plurality of clusters,
wherein the cluster analysis part is configured to:
select one of the plurality of entries from the cluster classification definition information; and
generate the plurality of clusters from the plurality of communication flows based on the first information included in the selected entry, and
wherein the cluster classification part is configured to:
analyze the plurality of clusters based on the second information included in the selected entry to calculate a plurality of classification values of the plurality of clusters; and
classify the plurality of clusters based on the plurality of calculated classification values.

15. The analysis apparatus according to claim 14,
wherein each of the plurality of entries included in the cluster classification definition information further includes third information is indicating a control policy that defines an action to be applied to the cluster, and
wherein the cluster classification part is configured to determine an action to be applied to each of the plurality of classified clusters based on the third information included in the selected entry.

16. The analysis apparatus according to claim 15, further including an execution part for determining whether there is an applicable action for each of the plurality of classified clusters based on the third information included in the selected entry, and applying the applicable action to the classified cluster in a case where there is the applicable action for the classified cluster.

17. The analysis apparatus according to claim 14,
wherein the analysis apparatus is configured to manage cluster history information that stores therein information on a history cluster, the history cluster being cluster that is not able to be classified based on the cluster classification definition information,
wherein the cluster history information includes a plurality of entries each including identification information of the history cluster, identification information of an entry included in the cluster classification definition information that is selected to classify a history cluster, the classification value of the history cluster, and a control policy that defines an action to be applied to the history cluster, and
wherein the cluster classification part is configured to:
select a target cluster from the plurality of generated clusters after being calculated the classification value of each of the plurality of clusters;
determine whether the target cluster can be classified based on the classification value of the target cluster;
refer to the cluster history information to determine whether there is the history cluster that matches the target cluster in a case where it is determined that the target cluster cannot be classified, and
determine an action to be applied to the target cluster based on the control policy corresponding to the history cluster that matches the target cluster in a case where it is determined that there is the history cluster that matches the target cluster.

18. The analysis apparatus according to claim 17,
wherein the cluster classification part is configured to register the target cluster in the cluster history information as a new history cluster in a case where it is determined that there is not the history cluster that matches the target cluster.
